(19) United States
(12) Patent Application Publication
(10) Pub. No.: US 2017/0122751 A1
(43) Pub. Date: May 4, 2017

(54) METHOD FOR ACQUIRING MAP INFORMATION, NAVIGATION METHOD AND EQUIPMENT

(71) Applicant: Leauto Intelligent Technology (BEIJING) Co. Ltd, Chaoyang District Beijing (CN)

(72) Inventors: Wenrui LI, Chaoyang District Beijing (CN); Yong XU, Chaoyang District Beijing (CN); Yu ZOU, Chaoyang District Beijing (CN); Kunsheng CHEN, Chaoyang District Beijing (CN); Wei LIN, Chaoyang District Beijing (CN); Peng LIU, Chaoyang District Beijing (CN); Dan LI, Chaoyang District Beijing (CN)

(73) Assignees: Leauto Intelligent Technology (BEIJING) Co. Ltd, Chaoyang District Beijing (CN); Leauto Intelligent Technology (BEIJING) Co. Ltd, Chaoyang District Beijing (CN)

(21) Appl. No.: 14/960,958

(22) Filed: Dec. 7, 2015

(30) Foreign Application Priority Data
Oct. 29, 2015 (CN) 201510717764.7

(51) Int. Cl. G01C 21/34; H04W 4/00

(52) U.S. Cl. CPC G01C 21/34; H04W 4/008

(57) ABSTRACT

Embodiments of the disclosure provide a method for acquiring map information, a navigation method and equipment. The method for acquiring map information specifically comprises: sending a map information request to roadside equipment corresponding to the current position, wherein the vehicle terminal communicates with the roadside equipment through a short range communication protocol; and receiving map information returned by the roadside equipment according to the map information request, wherein the map information is map information within a preset geographical range stored by the roadside equipment. The embodiments of the disclosure can save the storage space of the vehicle terminal and save the traffic fee of the vehicle terminal.

### CROSS-REFERENCE TO RELATED APPLICATIONS

The present disclosure is based upon and claims priority to Chinese Patent Application No. 201510717764.7, filed on Oct. 29, 2015, the entire contents of which are incorporated herein by reference.

### FIELD OF TECHNOLOGY

Embodiments of the present disclosure relate to the technical field of communications, and particularly relate to a method for acquiring map information, a navigation method and equipment.

### BACKGROUND

With continuous development of electronic information technology, electronic maps have gradually replaced paper maps, to bring convenience to people's outgoing. For example, in the travelling navigation technology, a vehicular navigator, a locomotive or other equipment may carry an electronic navigation system, to navigate the travelling route in real time according to an electronic map.

The existing travelling navigation technology may use an off-line electronic map or a real-time electronic map for navigation. In the technology using the off-line electronic map for navigation, a map information packet with a large data volume needs to be downloaded in advance before travelling navigation, the size of the map information packet generally may reach hundreds or thousands of megabytes, and when the map information is changed, the map information packet needs to be updated in advance. In the technology using the real-time electronic map, required map information needs to be downloaded in real time during travelling navigation, but more mobile traffic is consumed, and the technology is easily influenced by network signals and network speed.

Therefore, using the off-line electronic map has the problems that large storage space is needed and that the update is not in time, and using the real-time electronic map has the problems of high traffic consumption and limitation of the network state.

### SUMMARY

Embodiments of the present disclosure provide a method for acquiring map information, a navigation method and equipment, to overcome the shortcomings that an off-line electronic map needs large storage capacity and may be updated not in time and that a real-time electronic map is high in traffic consumption and is limited by the network state, thus implementing the method for acquiring map information capable of updating a local map in real time and free from the limitation of the network state and the traffic.

An embodiment of the present disclosure provides a method for acquiring map information, applied to a vehicle terminal, including:

sending a map information request to roadside equipment corresponding to the current position, wherein the vehicle terminal communicates with the roadside equipment through a short range communication protocol; and

receiving map information returned by the roadside equipment according to the map information request, wherein the map information is map information within a preset geographical range stored by the roadside equipment.

According to another aspect of the present disclosure, provided is a method for acquiring map information, applied to roadside equipment, including:

receiving a map information request from a vehicle terminal, wherein the vehicle terminal communicates with the roadside equipment through a short range communication protocol; and

sending stored map information to the vehicle terminal, wherein the map information is map information within a preset geographical range stored by the roadside equipment.

According to a further aspect of the present disclosure, provided is a navigation method, applied to a vehicle terminal, including:

sending a navigation request to roadside equipment corresponding to the current position, wherein the vehicle terminal communicates with the roadside equipment through a short range communication protocol, and the navigation request includes initial address information and destination address information;

receiving at least one kind of route information from the roadside equipment conforming to the initial address information and the destination address information;

determining target route information according to the selection operation of a user on the route information;

sending a map information request to the roadside equipment corresponding to the current position, wherein the vehicle terminal communicates with the roadside equipment through the short range communication protocol;

receiving map information returned by the roadside equipment according to the map information request, wherein the map information is map information within a preset geographical range stored by the roadside equipment;

generating navigation information according to the target route information and the map information; and

displaying the navigation information.

According to a still further aspect of the present disclosure, provided is a vehicle terminal, including:

a map information request module for sending a map information request to roadside equipment corresponding to the current position, wherein the vehicle terminal communicates with the roadside equipment through a short range communication protocol; and

a map information receiving module for receiving map information returned by the roadside equipment according to the map information request, wherein the map information is map information within a preset geographical range stored by the roadside equipment.

According to yet another aspect of the present disclosure, provided is roadside equipment, including:

a map request receiving module for receiving a map information request from a vehicle terminal, wherein the vehicle terminal communicates with the roadside equipment through a short range communication protocol; and

a map information sending module for sending stored map information to the vehicle terminal, wherein the map information is map information within a preset geographical range stored by the roadside equipment.

According to a still yet another aspect of the present disclosure, provided is a vehicle terminal, including:

a navigation request sending module for sending a navigation request to roadside equipment corresponding to the current position, wherein the vehicle terminal communicates with the roadside equipment through a short range communication protocol, and the navigation request includes initial address information and destination address information;

a route information receiving module for receiving at least one kind of route information from the roadside equipment conforming to the initial address information and the destination address information;

a target route determining module for determining target route information according to the selection operation of a user on the route information;

a map information request module for sending a map information request to the roadside equipment corresponding to the current position, wherein the vehicle terminal communicates with the roadside equipment through a short range communication protocol;

a map information receiving module for receiving map information returned by the roadside equipment according to the map information request, wherein the map information is map information within a preset geographical range stored by the roadside equipment;

a navigation information generating module for generating navigation information according to the target route information and the map information; and

a navigation information display module for displaying the navigation information.

According to the method for acquiring the map information, the navigation method and the equipment provided by the embodiments of the present disclosure, in the embodiments of the present disclosure, the vehicle terminal may interact with the roadside equipment corresponding to the current position, to request acquiring the map information stored by the roadside equipment, and then may obtain the map information within the range of the current position. Because only the map information within the preset geographical range stored by the roadside equipment corresponding to the current position needs to be downloaded in the embodiments of the present disclosure, the data volume is small, and compared with the prior art, the problem that a large storage space is needed for downloading a complete off-line electronic map is solved and the storage space of the vehicle terminal is saved; moreover, data interaction may be performed between a vehicle and the roadside equipment through the short range communication protocol, which possibly does not use traffic, so the present disclosure may also solve the problem that an on-line electronic map is limited by the network state and the traffic fee, the traffic fee of the vehicle terminal is saved, and thus the required map information is quickly and effectively acquired.

### BRIEF DESCRIPTION OF THE DRAWINGS

In order to describe the technical solutions in the embodiments of the present disclosure or in the prior art more clearly, a simple introduction to the accompanying drawings which are needed in the description of the embodiments or the prior art is given below. Apparently, the accompanying drawings in the description below are merely some of the embodiments of the present disclosure, and other drawings may be obtained according to these drawings by those of ordinary skill in the art without any creative effort.

FIG. 1 shows a step flow diagram of embodiment 1 of a method for acquiring map information in the present disclosure;

FIG. 2 shows a step flow diagram of embodiment 1 of a navigation method of the present disclosure;

FIG. 3 shows a step flow diagram of embodiment 2 of a method for acquiring map information in the present disclosure;

FIG. 4 shows a step flow diagram of embodiment 2 of a navigation method of the present disclosure;

FIG. 5 shows a structural block diagram of an embodiment of a navigation system of the present disclosure;

FIG. 6 shows a structural block diagram of an application example of a vehicle terminal of the present disclosure;

FIG. 7 shows a structural block diagram of an application example of roadside equipment of the present disclosure;

FIG. 8 shows a structural block diagram of embodiment 1 of the vehicle terminal of the present disclosure;

FIG. 9 shows a structural block diagram of an embodiment of the roadside equipment of the present disclosure; and

FIG. 10 shows a structural block diagram of embodiment 2 of the vehicle terminal of the present disclosure.

### DESCRIPTION OF THE EMBODIMENTS

To make the objectives, technical solutions and advantages of the embodiments of the present disclosure clearer, a clear and complete description of the technical solutions in the present disclosure will be given below, in conjunction with the accompanying drawings in the embodiments of the present disclosure. Apparently, the embodiments described below are a part, but not all, of the embodiments of the present disclosure. All other embodiments obtained by those of ordinary skill in the art based on the embodiments of the present disclosure without any creative effort fall into the protection scope of the present disclosure.

### Embodiment 1

Refer to FIG. 1, which shows a step flow diagram of embodiment 1 of a method for acquiring map information in the present disclosure. The method is applied to a vehicle terminal, and specifically may include the following steps.

Step 101, a map information request is sent to roadside equipment corresponding to the current position, wherein the vehicle terminal communicates with the roadside equipment through a short range communication protocol.

The embodiment of the present disclosure may be applied to acquiring map information during travelling navigation. In order to solve the problem of needing large storage space or high traffic consumption caused by downloading complete map information in the prior art, the map information within a preset geographical range may be stored in the roadside equipment in the embodiment of the present disclosure, wherein the preset geographical range may include a geographical area corresponding to the position of the roadside equipment, or a geographical area corresponding to the signal coverage of the roadside equipment. Further, the geographical area corresponding to the position of the roadside equipment may be a geographical position covering the position of the roadside equipment and having a preset size; for example, the geographical range corresponding to the position of the roadside equipment may be a circular area using the position of the roadside equipment as a circle center and using a first distance threshold as the radius; for another example, the geographical range corresponding to the position of the roadside equipment may also be a geographical area extending to the east, the south, the west, the north and other directions for a second distance threshold based on the position of the roadside equipment as a reference. The embodiments of the present disclosure do not limit the specific first distance threshold and second distance threshold and the specific preset geographical range.

Because each piece of roadside equipment only needs to store the map information with the preset geographical range, the data volume of the map information is relatively small; compared with the prior art, the vehicle terminal may acquire the corresponding map information by using the preset geographical range as granularity, so the storage space required by the vehicle terminal and the traffic required for downloading a map can be reduced. Taking the map information using the roadside equipment as a circle center and using two kilometers as the radius as an example, when a vehicle runs to the signal coverage of certain roadside equipment, the vehicle terminal may communicate with the roadside equipment through a V2X (Vehicle to X) technology to acquire the map information stored by the roadside equipment; and when the vehicle runs to the signal coverage of next roadside equipment, the next roadside equipment is requested for map information stored thereby, so that the required map information can be dynamically acquired during running.

In this case, V2X is a key technology of an intelligent transportation system, and enables a vehicle to communicate with another vehicle or a base station, so as to acquire a series of traffic information such as real-time road condition, road information, pedestrian information and the like.

In a preferred embodiment of the present disclosure, the V2X technology may be as follows: the vehicle terminal establishes a microwave communication link with the roadside equipment by using DSRC (Dedicated Short Range Communication) protocol, and communicates with the roadside equipment through microwave according to the established microwave communication link during running of the vehicle, to receive the map information returned by the roadside equipment according to the map information request. As the vehicle terminal may request the roadside equipment for the map information by using the short range communication protocol, which possibly does not use traffic, compared with the prior art, the traffic fee may be greatly reduced.

Step 102, map information returned by the roadside equipment according to the map information request is received, wherein the map information is map information within a preset geographical range stored by the roadside equipment.

In the embodiment of the present disclosure, the vehicle may dynamically request receiving the map information stored in the roadside equipment through the vehicle terminal during running, and the map information may be within the preset geographical range. For example, in an application example of the present disclosure, if a certain user needs to drive from Wudaokou subway station to Guomao subway station, then the user can dynamically download the corresponding local map information from Wudaokou subway station to Guomao subway station during driving, without downloading the map information of the whole Beijing at one time; with respect to the map information of the whole Beijing, the corresponding local map information from Wudaokou subway station to Guomao subway station is merely a part of the map information of the whole Beijing, so the data volume is relatively small, and the storage space required for downloading the map information by the vehicle terminal can be reduced.

In specific application, after receiving the map information from the roadside equipment, the vehicle terminal may further store the map information locally, so that when the vehicle passes through the current position next time, the vehicle terminal may not request the roadside equipment for the corresponding map information, to save the time for downloading the map information.

In a preferred embodiment of the present disclosure, the method may further include: integrating the sequentially received map information from a plurality of pieces of roadside equipment. Specifically, during running of the vehicle, the vehicle terminal may sequentially receive the map information from a plurality of pieces of roadside equipment according to advancing of the vehicle; as the map information stored by two pieces of roadside equipment in practical application may include repeated information, the vehicle terminal may further remove the repeated information from the received map information of the plurality of pieces of roadside equipment and integrate the map information, to obtain continuous map information.

For example, during the process that the vehicle runs from Wudaokou to the North Gate of Beihang, the vehicle terminal sequentially receives the map information from three pieces of roadside equipment in Wudaokou, Zhanchun Park and the North Gate of Beihang, wherein the map information of the roadside equipment in Wudaokou includes map information of a road section starting from Wudaokou, turning east along the Chengfu Road and ending at the West Zhanchun Park Road; the map information of the roadside equipment in the Zhanchun Park includes map information of a road section turning south along the West Zhanchun Park Road and ending at the side road of the Middle North Fourth Ring Road; the map information of the roadside equipment in the North Gate of Beihang includes map information of a road section turning east along the side road of the Middle North Fourth Ring Road and ending at the North Gate of Beihang; and the map information of the three pieces of roadside equipment may be integrated, to obtain continuous map information from Wudaokou to the North Gate of Beihang. The preset geographical ranges stored by the adjacent roadside equipment may be crossed, so that the map information of the adjacent roadside equipment may include repeated information, e.g. both the roadside equipment in Wudaokou and the roadside equipment in Zhanchun Park store the map information of a certain section of the West Zhanchun Park Road, so when the map information of the two pieces of roadside equipment is integrated, the repeated map information therein may be removed, to avoid the storage of redundant data and save the storage space.

To sum up, in the embodiment of the present disclosure, during running of the vehicle, the vehicle terminal may interact with the roadside equipment corresponding to the current position, to request the roadside equipment for the corresponding map information, and then may obtain the map information within the range of the current position. Because only the map information within the preset geographical range stored by the roadside equipment corresponding to the current position needs to be downloaded in the embodiment of the present disclosure, the data volume is small, and thus compared with the prior art, the problem of large storage space needed for downloading a complete off-line electronic map is solved; moreover, data interaction may be performed between the vehicle and the roadside equipment through the short range communication protocol, which possibly does not use traffic, so the problem that an on-line electronic map is limited by the network state and the traffic fee may be further solved, and the required map information is quickly and effectively acquired.

### Embodiment 2

The embodiment of the present disclosure further provides a method for implementing navigation according to the map information acquired in embodiment 1. Specifically, before navigation, a navigation request which may include initial address information and destination address information is sent to the roadside equipment, to acquire route information corresponding to the navigation request; and then target route information may be determined, so that navigation information may be generated according to the map information requested from the roadside equipment and the target route information during running, to achieve travelling navigation.

In an application example of the present disclosure, it is supposed that a vehicle is about to start from the current position (site A) and arrive at site B but does not know the running route, the target route information may be determined first, wherein the target route information generally includes a locus graph from site A to site B and corresponding literal description on the map, and the locus graph generally includes a plurality of discrete position points passed from site A to site B and the direction formed between the adjacent position points, but generally does not include map information between the adjacent position points, so the navigation further needs the map information besides the above locus graph. For example, with respect to the application example, according to the locus graph, only the following information may be learnt: starting from Wudaokou subway station, turning east along the Chengfu Road, running 190 meters, turning right and entering the West Zhanchun Park Road, but the general view of the Chengfu Road and the West Zhanchun Park Road during running may not be learnt.

In the above application example, during the process that the vehicle turns east along the Chengfu Road according to the target route information, the roadside equipment nearby the current position of the vehicle may be requested for the map information stored by the roadside equipment; and after the map information is received, the locus graph of the corresponding range in the target route information can be filled and added with the corresponding map information to generate navigation information for navigation.

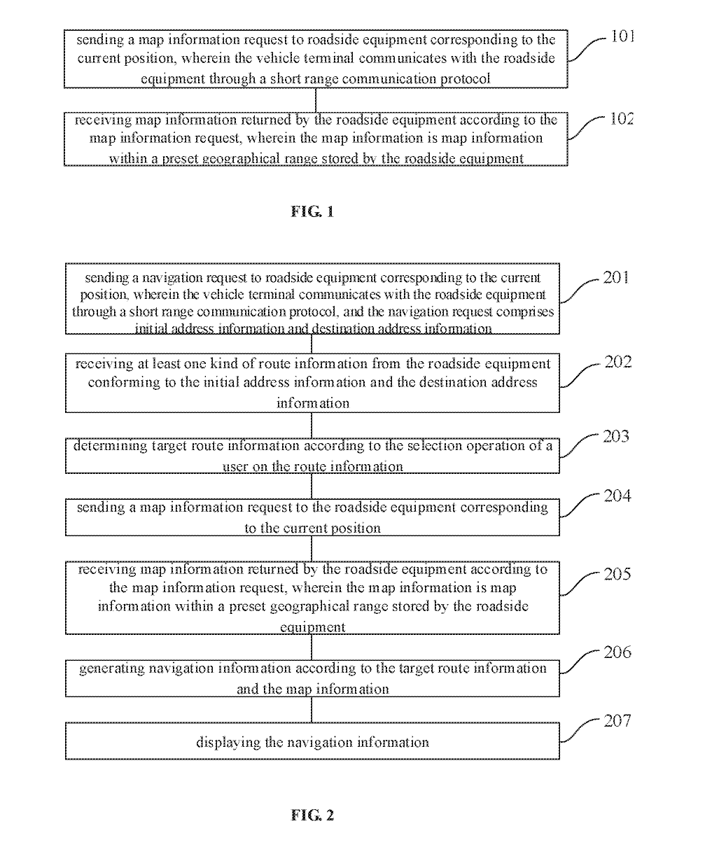

Refer to FIG. 2, which shows a step flow diagram of embodiment 1 of a navigation method of the present disclosure. The navigation method is applied to a vehicle terminal, and specifically may include the following steps.

Step 201, a navigation request is sent to roadside equipment corresponding to the current position, wherein the vehicle terminal communicates with the roadside equipment through a short range communication protocol, and the navigation request includes initial address information and destination address information.

In the embodiment of the present disclosure, before navigation, a user may send the navigation request to the roadside equipment corresponding to the current position through the vehicle terminal to acquire route information, wherein the navigation request may include initial address information and destination address information, and the initial address information specifically may be current position information of the vehicle. In practical application, the current position information may be acquired through the vehicle terminal by using but not limited to a GPS (Global Positioning System), a BDS (BeiDou Navigation Satellite System), a GLONASS (Glonass Navigation Satellite System), etc.

Step 202, at least one kind of route information from the roadside equipment conforming to the initial address information and the destination address information is received.

In the embodiment of the present disclosure, the process of planning the route information may be implemented by a server, specifically, the roadside equipment may send the received navigation request to the server, the server plans the route information according to the initial address information and the destination address information and sends at least one kind of planned route information to the roadside equipment, and the roadside equipment sends the route information to the vehicle terminal.

The route information specifically may include a locus graph between an initial address and a destination address as well as corresponding literal description. In order to provide more and more flexible navigation choices for users, the route information may be locus graphs corresponding to multiple route schemes (multiple optional schemes such as shortest time, shortest distance, lowest fee and the like), but does not include detailed navigation map information, and the users can select the appropriate route information as the target route information. It could be understood that the specific mode for determining the target route information is not limited in the present disclosure.

Step 203, target route information is determined according to the selection operation of a user on the route information.

In specific application, the vehicle terminal may display the received at least one kind of route information in a display interface, so that the user may select at least one kind of route information as the target route information.

Step 204, a map information request is sent to the roadside equipment corresponding to the current position.

Step 205, map information returned by the roadside equipment according to the map information request is received, wherein the map information is map information within a preset geographical range stored by the roadside equipment.

Step 206, navigation information is generated according to the target route information and the map information.

In specific application, the locus graph corresponding to the target route information may be filled according to the map information, to obtain route information which can be used or navigation and includes map data.

In this case, the map information specifically may include ground object information and road information, and the step of generating the navigation information according to the target route information and the map information acquired by the above method specifically may include:

determining ground object information and road information corresponding to the target route information according to the map information; and

generating the navigation information corresponding to the target route information according to the ground object information and the road information.

In practical application, a map may be regarded as being composed of three geometrical figures including points, lines and planes, wherein the points indicate practical ground objects, lines are entities such as roads and railways, and the entities for dividing the points and the lines may be represented by the planes. The process of generating the navigation information is to enable the target route to correspond to the point and line entities included in the route, so that the target route information has such information as coordinates, names and the like of ground objects and roads for navigation. For example, in the above application example of the present disclosure, it is supposed that the vehicle is about to start from the current position (site A) and arrive at site B, the target route information about travelling from site A to site B may be determined first, only the following information may be learnt: starting from Wudaokou subway station, turning east along the Chengfu Road, running 190 meters, turning right and entering the West Zhanchun Park Road, but the general view of the Chengfu Road and the West Zhanchun Park Road during running may not be learnt. After the map information of the corresponding roadside equipment in the West Zhanchun Park Road and the Chengfu Road is acquired, the corresponding ground object information and road information of the West Zhanchun Park Road and the Chengfu Road in the map information may be added to the target route information, that is, the map information may be fused with the target route information, to obtain navigation information for navigation.

Step 207, the navigation information is displayed.

In the embodiment of the present disclosure, before travelling navigation begins, the vehicle terminal may send the navigation request to the roadside equipment corresponding to the current position, receive at least one kind of route information from the roadside equipment conforming to the initial address information and the destination address information, then determine the target route information, request the roadside equipment corresponding to the current position for the map information stored by the roadside equipment during running of the vehicle, generate the navigation information according to the received map information from the roadside equipment and the target route information, and display the navigation information to achieve a navigation function.

Through the embodiment of the present disclosure, appropriate route information may be acquired in real time according to needs, and during running of the vehicle, the local map information stored by the roadside equipment is acquired in real time according to the current position through the short range communication protocol, and the navigation information may be generated according to the route information and the map information, so that a process of dynamically generating navigation information is achieved, and compared with the existing travelling navigation technology, the problems of large data volume for downloading a map and high traffic consumption in the navigation process are solved. Moreover, in the embodiment of the present disclosure, the route information may be acquired through the short range communication protocol, which possibly does not use traffic, so compared with the existing travelling navigation process, traffic can be saved.

### Embodiment 3

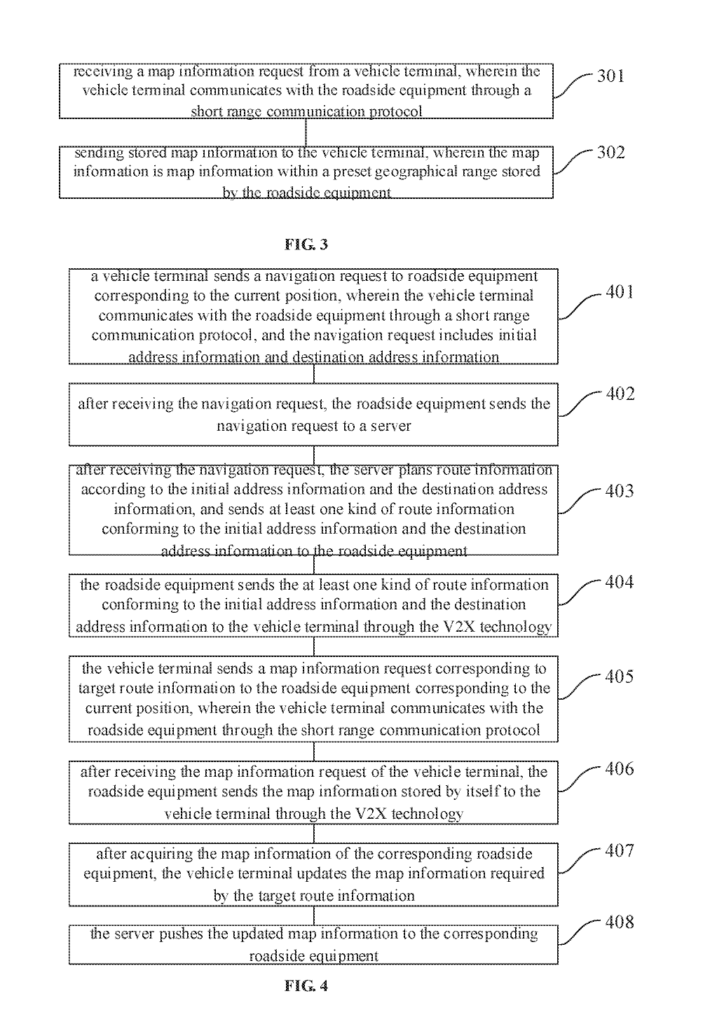

Refer to FIG. 3, which shows a step flow diagram of embodiment 2 of a method for acquiring map information in the present disclosure. The method is applied to roadside equipment, and specifically may include the following steps.

Step 301, a map information request from a vehicle terminal is received, wherein the vehicle terminal communicates with the roadside equipment through a short range communication protocol.

In the embodiment of the present disclosure, when a vehicle runs to the signal coverage of the roadside equipment, the roadside equipment may receive the map information request from the vehicle terminal.

Step 302, the stored map information is sent to the vehicle terminal, wherein the map information is map information within a preset geographical range stored by the roadside equipment.

In the embodiment of the present disclosure, in order to reduce the storage burden of the roadside equipment and the data transmission quantity between the vehicle terminal and the roadside equipment, the roadside equipment may store the map information only within the position range thereof, the data volume of the map information is very small, while complete map information with a large data volume is stored in a server. It could be understood that, in practical application, the data volume of the map information stored in the roadside equipment may be determined according to needs; and the present disclosure does not limit the data volume of the map information stored in the roadside equipment. In specific application, the roadside equipment may be connected to the Internet or a dedicated network through the traditional Ethernet, to communicate with a server, and the server may be further used for planning route information in addition to storing map information with a large data volume.

In specific application, the roadside equipment may be further used for receiving a navigation request from the vehicle terminal, sending the navigation request to the server which plans the route information corresponding to the navigation request, and sending at least one kind of route information from the server to the vehicle terminal, specifically, the roadside equipment may further implement the following steps:

receiving a navigation request from the vehicle terminal, wherein the navigation request includes initial address information and destination address information;

sending the navigation request to the server;

receiving at least one kind of route information from the server conforming to the initial address information and the destination address information; and

sending the at least one kind of route information conforming to the initial address information and the destination address information to the vehicle terminal.

In order to ensure the accuracy of the map information in the roadside equipment, in another preferred embodiment of the present disclosure, the method may further include:

receiving updated map information pushed by the server; and

updating the stored map information according to the updated map information.

In the embodiment of the present disclosure, after the map information in the server is updated, the server can push the updated content to the corresponding roadside equipment, to solve the problem that the off-line electronic map is not updated in time, thus ensuring the accuracy of the map information in the roadside equipment.

### Embodiment 4

In order to describe the navigation method of the present disclosure more clearly, the navigation method of the present disclosure will be described in detail in this embodiment in combination with specific application examples.

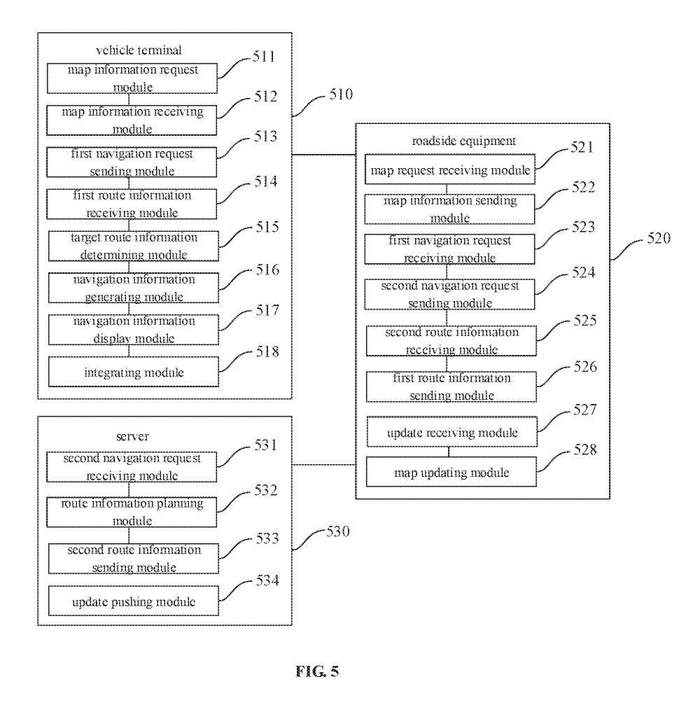

Refer to FIG. 4, which shows a step flow diagram of embodiment 2 of a navigation method of the present disclosure. The navigation method specifically may include the following steps.

Step 401, a vehicle terminal sends a navigation request to roadside equipment corresponding to the current position, wherein the vehicle terminal communicates with the roadside equipment through a short range communication protocol, and the navigation request includes initial address information and destination address information.

In an application example of the present disclosure, the current position of the vehicle is the initial address information, and the vehicle terminal may automatically organize a network with the roadside equipment nearby through a V2X technology and send the navigation request to the roadside equipment through the V2X technology.

Step 402, after receiving the navigation request, the roadside equipment sends the navigation request to a server.

Specifically, the roadside equipment may be connected to the Internet or a dedicated network through the traditional Ethernet, to communicate with the server. After receiving the navigation request from the vehicle terminal, the roadside equipment sends the navigation request to the server through the Ethernet. In specific application, when the roadside equipment sends the navigation request to the server, identification information and position information of the roadside equipment may also be added to the navigation request, so that the server can return corresponding data information to the corresponding roadside equipment.

Step 403, after receiving the navigation request, the server plans route information according to the initial address information and the destination address information, and sends at least one kind of route information conforming to the initial address information and the destination address information to the roadside equipment.

In the embodiment of the present disclosure, the server stores complete map information, and can plan the route information according to the initial address information and the destination address information after receiving the navigation request.

Step 404, the roadside equipment sends the at least one kind of route information conforming to the initial address information and the destination address information to the vehicle terminal through the V2X technology.

Step 405, the vehicle terminal sends a map information request corresponding to target route information to the roadside equipment corresponding to the current position, wherein the vehicle terminal communicates with the roadside equipment through the short range communication protocol.

In the embodiment of the present disclosure, the at least one kind of route information conforming to the initial address information and the destination address information may be displayed through the vehicle terminal, the user selects one kind of route information as the target route information, and during running of the vehicle, the vehicle terminal requests the roadside equipment corresponding to the current position for map information stored by the roadside equipment, and synthetically outputs the map information and the target route information, so as to generate navigation information.

Step 406, after receiving the map information request of the vehicle terminal, the roadside equipment sends the map information stored by itself to the vehicle terminal through the V2X technology.

Step 407, after acquiring the map information of the corresponding roadside equipment, the vehicle terminal updates the map information required by the target route information.

In the embodiment of the present disclosure, after acquiring the map information of the corresponding roadside equipment, the vehicle terminal continuously fills the target route information, to update the required detailed map information in real time along with continuous advancing of the vehicle.

Step 408, the server pushes the updated map information to the corresponding roadside equipment.

Through the embodiment of the present disclosure, during navigation, only the map information stored by the roadside equipment corresponding to the current position needs to be downloaded, so the data volume is small, and compared with the prior art, the problem of large storage space needed for downloading a complete off-line electronic map is solved; moreover, data interaction may be performed between the vehicle and the roadside equipment through the short range communication protocol, and the map information may be transmitted without a mobile network, so the problem that an on-line electronic map is limited by the network state and the traffic fee may be further solved, and the required map information is quickly and effectively acquired.

Embodiment 5

Refer to FIG. 5, which shows a structural block diagram of an embodiment of a navigation system of the present disclosure. The navigation system specifically may include a vehicle terminal 510 and roadside equipment 520.

The vehicle terminal 510 and the roadside equipment 520 can automatically organize a network through the V2X technology, and communication between the vehicle terminal 510 and the roadside equipment 520 can be achieved through the V2X technology.

In this case, the vehicle terminal 510 is carried by a vehicle, is a terminal part of the navigation system, and can be used for initiating a navigation request, displaying map information, receiving map information in real time and the like. The vehicle terminal 510 specifically may include:

a map information request module 511 for sending a map information request to roadside equipment corresponding to the current position, wherein the vehicle terminal communicates with the roadside equipment through a short range communication protocol; and

a map information receiving module 512 for receiving map information returned by the roadside equipment according to the map information request, wherein the map information is map information within a preset geographical range stored by the roadside equipment.

The roadside equipment 520 is deployed beside a road, and can be used for communicating with the vehicle terminal and a server. The roadside equipment 520 specifically may include:

a map request receiving module 521 for receiving a map information request from the vehicle terminal and in correspondence with target route information, wherein the vehicle terminal communicates with the roadside equipment through the short range communication protocol; and

a map information sending module 522 for sending the stored map information to the vehicle terminal, wherein the map information is map information within a preset geographical range stored by the roadside equipment.

In a preferred embodiment of the present disclosure, the system may further include a server 530.

The roadside equipment 520 may be connected to the Internet or a dedicated network through the traditional Ethernet, to communicate with the server 530.

The server 530 is a background processing part of the navigation system, and can be used for processing a navigation request, planning and sending route information, updating and pushing updated map information and the like. The server 530 specifically may include:

a second navigation request receiving module 531 for receiving a navigation request from the roadside equipment, wherein the navigation request includes initial address information and destination address information;

a route information planning module 532 for planning route information according to the map information stored by the server as well as the initial address information and the destination address information; and

a second route information sending module 533 for sending at least one kind of route information conforming to the initial address information and the destination address information to the roadside equipment.

The vehicle terminal 510 may further include:

a first navigation request sending module 513 for sending a navigation request to the roadside equipment corresponding to the current position, wherein the vehicle terminal communicates with the roadside equipment through the short range communication protocol, and the navigation request includes initial address information and destination address information;

a first route information receiving module 514 for receiving at least one kind of route information from the roadside equipment conforming to the initial address information and the destination address information;

a target route information determining module 515 for determining one of the at least one kind of route information as target route information;

a navigation information generating module 516 for generating navigation information according to the target route information and the map information; and

a navigation information display module 517 for displaying the navigation information.

In a preferred embodiment of the present disclosure, the vehicle terminal may further include:

an integrating module 518 for integrating the sequentially received map information from a plurality of pieces of roadside equipment.

The roadside equipment 520 may further include:

a first navigation request receiving module 523 for receiving a navigation request from the vehicle terminal, wherein the navigation request includes initial address information and destination address information;

a second navigation request sending module 524 for sending the navigation request to the server;

a second route information receiving module 525 for receiving at least one kind of route information from the server conforming to the initial address information and the destination address information; and

a first route information sending module 526 for sending the at least one kind of route information conforming to the initial address information and the destination address information to the vehicle terminal.

In another preferred embodiment of the present disclosure, the server may further include an update pushing module 534;

the update pushing module 534 is used for, after the map information stored by the sever is updated, pushing the updated map information to the corresponding roadside equipment.

The roadside equipment 520 may further include:

an update receiving module 527 for receiving updated map information pushed by the server; and

a map updating module 528 for updating the stored map information according to the updated map information.

In the embodiment of the present disclosure, the vehicle terminal may interact with the roadside equipment corresponding to the current position through the V2X technology, to request acquiring the map information stored by the roadside equipment, and then may obtain the map information within the range of the current position. Because only the map information stored by the roadside equipment corresponding to the current position needs to be downloaded in the embodiment of the present disclosure, so the data volume is small, and compared with the prior art, the problem of large storage space needed for downloading a complete off-line electronic map is solved; moreover, data interaction may be performed between the vehicle and the roadside equipment through the short range communication protocol without using a mobile network, so the problem that an on-line electronic map is limited by the network state and the traffic fee may be further solved, and the required map information is quickly and effectively acquired.

### APPLICATION EXAMPLES

The above navigation system of the present disclosure will be described in detail below in conjunction with a specific application scenario. In an application example of the present disclosure, the navigation system may include a vehicle terminal, roadside equipment and a server.

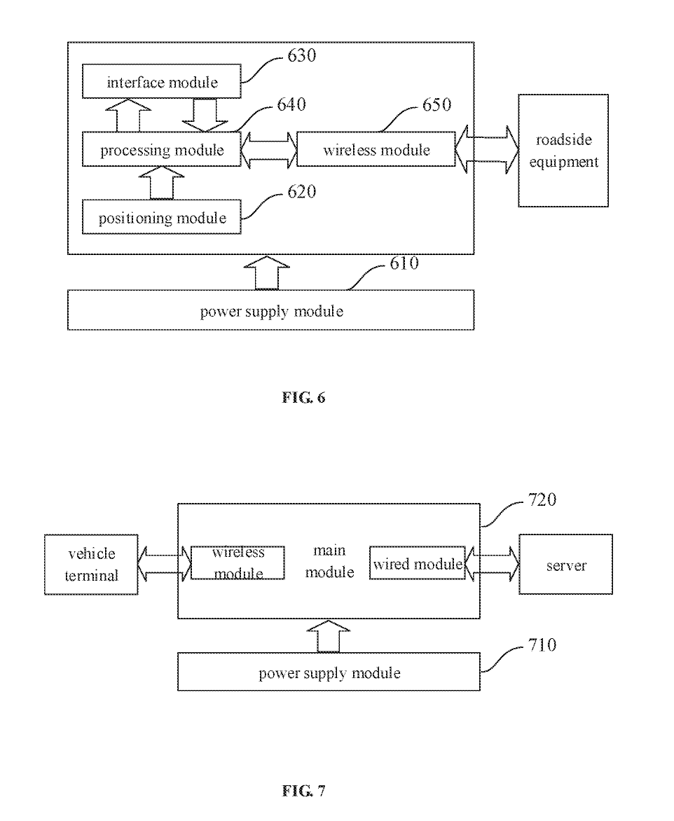

Refer to FIG. 6, which shows a structural block diagram of an application example of the vehicle terminal of the present disclosure. The vehicle terminal specifically may include a power supply module 610, a positioning module 620, an interface module 630, a processing module 640 and a wireless module 650;

the power supply module 610 is used for supplying power to other modules, and includes but not limited to a storage battery, a vehicle power supply, etc.;

the positioning module 620 is used for acquiring current position information in a mode including but not limited to GPS, BDS, GLONASS, etc., and then transmitting the current position information to a processing module;

the interface module 630 is used for inputting a navigation request and displaying route information and map information;

specifically, a user may input the navigation request on a graphical interface, e.g. input a destination address, and the interface module transmits the navigation request to the processing module.

The processing module 640 is used for integrating each module and processing data.

In specific application, the processing module serving as a sending end can acquire the current position information transmitted by the positioning module and the destination address transmitted by the display module and then send the information to a wireless module; and the processing module serving as a receiving end can acquire route information or map information sent by roadside equipment from the wireless module.

The wireless module 650 is used for communicating with the roadside equipment through the V2X technology.

Refer to FIG. 7, which shows a structural block diagram of an application example of the roadside equipment of the present disclosure. The roadside equipment specifically may include:

a power supply module 710 for supplying power to other modules, including but not limited to a storage battery, a vehicle power supply, etc.; and

a main module 720 for storing position information of the roadside equipment and map information of the range of the position information and processing and forwarding relevant data. Specifically, the main module may communicate with a vehicle terminal through a wireless module, e.g. receive a navigation request from the vehicle terminal through a wireless network and send map information to the vehicle terminal and the like; and the main module may further communicate with a server through a wired module, e.g. receive route information and map information from the server through the Ethernet and the like.

### Device Embodiment 1

Refer to FIG. 8, which shows a structural block diagram of embodiment 1 of the vehicle terminal of the present disclosure. The vehicle terminal specifically may include:

a map information request module 810 for sending a map information request to roadside equipment corresponding to the current position, wherein the vehicle terminal communicates with the roadside equipment through a short range communication protocol; and

a map information receiving module 820 for receiving map information returned by the roadside equipment according to the map information request, wherein the map information is map information within a preset geographical range stored by the roadside equipment.

In a preferred embodiment of the present disclosure, the vehicle terminal may further include:

an integrating module for integrating the sequentially received map information from a plurality of pieces of roadside equipment.

In another preferred embodiment of the present disclosure, the vehicle terminal may further include:

a first link establishment module for establishing a microwave communication link with the roadside equipment according to the short range communication protocol;

the map information request module specifically may include:

a map information request sub-module for sending a map information request to roadside equipment corresponding to the current position according to the microwave communication link;

the map information receiving module specifically may include:

a map information receiving sub-module for, according to the microwave communication link, receiving map information returned by the roadside equipment according to the map information request.

### Device Embodiment 2

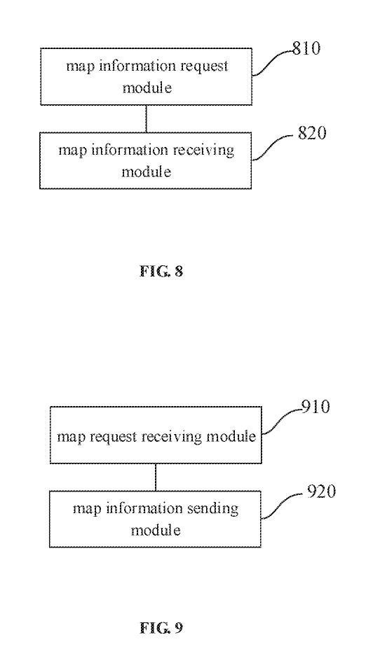

Refer to FIG. 9, which shows a structural block diagram of an embodiment of the roadside equipment of the present disclosure. The roadside equipment specifically may include:

a map request receiving module 910 for receiving a map information request from a vehicle terminal and in correspondence to target route information, wherein the vehicle terminal communicates with the roadside equipment through a short range communication protocol; and

a map information sending module 920 for sending stored map information to the vehicle terminal, wherein the map information is map information within a preset geographical range stored by the roadside equipment.

In a preferred embodiment of the present disclosure, the roadside equipment may further include:

an update receiving module for receiving updated map information pushed by a server; and

a map updating module for updating the stored map information according to the updated map information.

In another preferred embodiment of the present disclosure, the roadside equipment may further include:

a second link establishment module for establishing a microwave communication link with the vehicle terminal according to the short range communication protocol;

the map request receiving module specifically may include:

a map request receiving sub-module for receiving a map information request from the vehicle terminal according to the microwave communication link;

the map information sending module specifically may include:

a map information sending sub-module for sending the stored map information to the vehicle terminal according to the microwave communication link.

### Device Embodiment 3

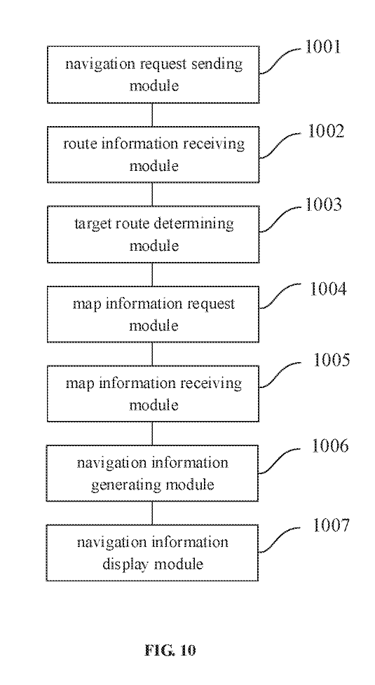

Refer to FIG. 10, which FIG. 10 shows a structural block diagram of embodiment 2 of the vehicle terminal of the present disclosure. The vehicle terminal specifically may include:

a navigation request sending module 1001 for sending a navigation request to roadside equipment corresponding to the current position, wherein the vehicle terminal communicates with the roadside equipment through a short range communication protocol, and the navigation request includes initial address information and destination address information;

a route information receiving module 1002 for receiving at least one kind of route information from the roadside equipment conforming to the initial address information and the destination address information;

a target route determining module 1003 for determining target route information according to the selection operation of a user on the route information;

a map information request module 1004 for sending a map information request to the roadside equipment corresponding to the current position, wherein the vehicle terminal communicates with the roadside equipment through the short range communication protocol;

a map information receiving module 1005 for receiving map information returned by the roadside equipment according to the map information request, wherein the map information is map information within a preset geographical range stored by the roadside equipment;

a navigation information generating module 1006 for generating navigation information according to the target route information and the map information; and

a navigation information display module 1007 for displaying the navigation information.

In a preferred embodiment of the present disclosure, the map information may include ground object information and road information, and the navigation information generating module 1006 specifically may include:

an information determining sub-module for determining ground object information and road information corresponding to the target route information according to the map information; and

a navigation generating sub-module for generating navigation information corresponding to the target route information according to the ground object information and the road information.

### Device Embodiment 4

A vehicle terminal, including: a processor; and a memory for storing instructions executable by the processor; wherein the processor is configured to: send a map information request to roadside equipment corresponding to the current position, wherein the vehicle terminal communicates with the roadside equipment through a short range communication protocol; and receive map information returned by the roadside equipment according to the map information request, wherein the map information is map information within a preset geographical range stored by the roadside equipment.

The processor is further configured to: integrate the sequentially received map information from a plurality of pieces of roadside equipment.

The processor is further configured to: establish a microwave communication link with the roadside equipment according to the short range communication protocol; send a map information request to roadside equipment corresponding to the current position according to the microwave communication link; according to the microwave communication link, receive map information returned by the roadside equipment according to the map information request.

A roadside equipment, including: a processor; and a memory for storing instructions executable by the processor; wherein the processor is configured to: receive a map information request from a vehicle terminal, wherein the vehicle terminal communicates with the roadside equipment through a short range communication protocol; and send stored map information to the vehicle terminal, wherein the map information is map information within a preset geographical range stored by the roadside equipment.

The processor is further configured to: receive updated map information pushed by a server; and update the stored map information according to the updated map information.

The processor is further configured to: establish a microwave communication link with the vehicle terminal according to the short range communication protocol; receive a map information request from the vehicle terminal according to the microwave communication link; send the stored map information to the vehicle terminal according to the microwave communication link.

A vehicle terminal, comprising: a processor; and a memory for storing instructions executable by the processor; wherein the processor is configured to: send a navigation request to roadside equipment corresponding to the current position, wherein the vehicle terminal communicates with the roadside equipment through a short range communication protocol, and the navigation request comprises initial address information and destination address information; receive at least one kind of route information from the roadside equipment conforming to the initial address information and the destination address information; determine target route information according to the selection operation of a user on the route information; send a map information request to the roadside equipment corresponding to the current position, wherein the vehicle terminal communicates with the roadside equipment through a short range communication protocol; receive map information returned by the roadside equipment according to the map information request, wherein the map information is map information within a preset geographical range stored by the roadside equipment; generate navigation information according to the target route information and the map information; and display the navigation information, wherein the map information comprises ground object information and road information, and the processor is further configured to: determine ground object information and road information corresponding to the target route information according to the map information; and generate navigation information corresponding to the target route information according to the ground object information and the road information.

The device embodiments described above are only exemplary, wherein the units illustrated as separate components may be or may not be physically separated, and the components displayed as units may be or may not be physical units, that is to say, the components may be positioned at one place or may also be distributed on a plurality of network units. The objectives of the solutions of the embodiments may be achieved by selecting part of or all of the modules according to actual needs. Those of ordinary skill in the art could understand and implement the embodiments without any creative effort.

Through the descriptions of the above embodiments, those skilled in the art could clearly learn that each embodiment may be implemented by means of software and a necessary general hardware platform, and of course, may be implemented by hardware. Based on such a understanding, the above technical solutions substantially or the part making contribution to the prior art may be embodied in the form of a software product, and the computer software product is stored in a computer readable storage medium, such as an ROM (Read-Only Memory)/RAM (Random Access Memory), a disk, an optical disk and the like, which includes a plurality of instructions enabling computer equipment (which may be a personal computer, a server, or network equipment and the like) to execute the method in each embodiment or in some part of each embodiment.

Finally, it should be noted that the above embodiments are merely used for illustrating rather than limiting the technical solutions of the present disclosure; although the present disclosure is illustrated in detail with reference to the aforementioned embodiments, it should be understood by those of ordinary skill in the art that modifications may still be made on the technical solutions disclosed in the aforementioned embodiments, or equivalent substitutions may be made to part of technical features thereof, without making, by these modifications or substitutions, the nature of the corresponding technical solutions depart from the spirit and scope of the technical solutions of the embodiments of the present disclosure.

What is claimed is:

1. A method for acquiring map information, applied to a vehicle terminal, and comprising:
sending a map information request to roadside equipment corresponding to the current position, wherein the vehicle terminal communicates with the roadside equipment through a short range communication protocol; and
receiving map information returned by the roadside equipment according to the map information request, wherein the map information is map information within a preset geographical range stored by the roadside equipment.

2. The method of claim 1, further comprising:
integrating the sequentially received map information from a plurality of pieces of roadside equipment.

3. The method of claim 1, further comprising:
establishing a microwave communication link with the roadside equipment according to the short range communication protocol;
the step of sending a map information request to roadside equipment corresponding to the current position comprising:
sending a map information request to roadside equipment corresponding to the current position according to the microwave communication link;
the step of receiving map information returned by the roadside equipment according to the map information request comprising:
according to the microwave communication link, receiving map information returned by the roadside equipment according to the map information request.

4. A method for acquiring map information, applied to roadside equipment, comprising:
receiving a map information request from a vehicle terminal, wherein the vehicle terminal communicates with the roadside equipment through a short range communication protocol; and
sending stored map information to the vehicle terminal, wherein the map information is map information within a preset geographical range stored by the roadside equipment.

5. The method of claim 4, further comprising:
receiving updated map information pushed by a server; and
updating the stored map information according to the updated map information.

6. The method of claim 4, further comprising:
establishing a microwave communication link with the vehicle terminal according to the short range communication protocol;
the step of receiving a map information request from a vehicle terminal comprising:
receiving a map information request from a vehicle terminal according to the microwave communication link;
the step of sending the stored map information to the vehicle terminal comprising:
sending the stored map information to the vehicle terminal according to the microwave communication link.

7. A navigation method, applied to a vehicle terminal, comprising:
sending a navigation request to roadside equipment corresponding to the current position, wherein the vehicle terminal communicates with the roadside equipment through a short range communication protocol, and the navigation request comprises initial address information and destination address information;
receiving at least one kind of route information from the roadside equipment conforming to the initial address information and the destination address information;
determining target route information according to the selection operation of a user on the route information;
sending a map information request to the roadside equipment corresponding to the current position, wherein the vehicle terminal communicates with the roadside equipment through the short range communication protocol;
receiving map information returned by the roadside equipment according to the map information request, wherein the map information is map information within a preset geographical range stored by the roadside equipment;
generating navigation information according to the target route information and the map information; and
displaying the navigation information.

8. The method of claim 7, wherein the map information comprises ground object information and road information, and the step of generating navigation information according to the target route information and the map information comprises:
determining ground object information and road information corresponding to the target route information according to the map information; and
generating navigation information corresponding to the target route information according to the ground object information and the road information.

9. A vehicle terminal, comprising:
a processor; and
a memory for storing instructions executable by the processor;
wherein the processor is configured to:
send a map information request to roadside equipment corresponding to the current position, wherein the vehicle terminal communicates with the roadside equipment through a short range communication protocol; and
receive map information returned by the roadside equipment according to the map information request, wherein the map information is map information within a preset geographical range stored by the roadside equipment.

10. The vehicle terminal of claim 9, the processor is further configured to:
integrate the sequentially received map information from a plurality of pieces of roadside equipment.

11. The vehicle terminal of claim 9, the processor is further configured to:
establish a microwave communication link with the roadside equipment according to the short range communication protocol;
send a map information request to roadside equipment corresponding to the current position according to the microwave communication link;
according to the microwave communication link, receive map information returned by the roadside equipment according to the map information request.

12. Roadside equipment, comprising:
a processor; and
a memory for storing instructions executable by the processor;
wherein the processor is configured to:
receive a map information request from a vehicle terminal, wherein the vehicle terminal communicates with the roadside equipment through a short range communication protocol; and
send stored map information to the vehicle terminal, wherein the map information is map information within a preset geographical range stored by the roadside equipment.

13. The roadside equipment of claim 12, the processor is further configured to:
receive updated map information pushed by a server; and
update the stored map information according to the updated map information.

14. The roadside equipment of claim 12, the processor is further configured to:
establish a microwave communication link with the vehicle terminal according to the short range communication protocol;
receive a map information request from the vehicle terminal according to the microwave communication link;
send the stored map information to the vehicle terminal according to the microwave communication link.

15. A vehicle terminal, comprising:
a processor; and
a memory for storing instructions executable by the processor;
wherein the processor is configured to:
send a navigation request to roadside equipment corresponding to the current position, wherein the vehicle terminal communicates with the roadside equipment through a short range communication protocol, and the navigation request comprises initial address information and destination address information;
receive at least one kind of route information from the roadside equipment conforming to the initial address information and the destination address information;
determine target route information according to the selection operation of a user on the route information;
send a map information request to the roadside equipment corresponding to the current position, wherein the vehicle terminal communicates with the roadside equipment through a short range communication protocol;
receive map information returned by the roadside equipment according to the map information request, wherein the map information is map information within a preset geographical range stored by the roadside equipment;
generate navigation information according to the target route information and the map information; and
display the navigation information.

16. The vehicle terminal of claim 15, wherein the map information comprises ground object information and road information, and the processor is further configured to:
determine ground object information and road information corresponding to the target route information according to the map information; and
generate navigation information corresponding to the target route information according to the ground object information and the road information.
